(19) United States
(12) Patent Application Publication
(10) Pub. No.: US 2006/0119005 A1
(43) Pub. Date: Jun. 8, 2006

(54) Apparatus and method for vulcanizing tire

(76) Inventor: Hironobu Ichimaru, Fukuoka (JP)

Correspondence Address: FLYNN THIEL BOUTELL & TANIS, P.C., 2026 RAMBLING ROAD, KALAMAZOO, MI, 49008-1631, US

(21) Appl. No.: 10/524,299

(22) PCT Filed: Aug. 6, 2003
(86) PCT No.: PCT/JP03/10034

§ 371 Date: Feb. 4, 2005

(30) Foreign Application Priority Data
Aug. 7, 2002 (JP) 2002-230242

(51) Int. Cl. B29C 35/00

(52) U.S. Cl. 264/326; 425/35

(57) ABSTRACT

The invention provides a tire vulcanizing technique which can sufficiently secure a time for supplying a green tire by conveying the green tire to a tire supplying position during a vulcanizing and molding step which has the longest time in the tire vulcanizing step.

The invention provides a tire vulcanizing method provided with a tire conveying apparatus which reciprocates between a conveyance waiting position (X1) and a tire supplying position (X2), a tire elevating apparatus which elevates between an ascent holding position and a descent set position at the tire supplying position, a lower mold which reciprocates between the tire supplying position and a tire vulcanizing position, and an upper mold which elevates between a descent vulcanizing position and an ascent waiting position at the tire vulcanizing position. The tire conveyance supplying step to the tire conveyance returning step by the tire conveying apparatus are executed during the vulcanizing and molding step by the lower mold and the upper mold.

### TECHNICAL FIELD

The present invention relates to a tire vulcanizing apparatus and a tire vulcanizing method for continuously vulcanizing and molding a green tire (a raw tire), and more particularly to a technique for supplying the green tire to the tire vulcanizing apparatus.

### BACKGROUND ART

In conventional technique, a tire vulcanizing apparatus for continuously vulcanizing and molding a green tire is provided with a cradle for receiving the green tire, an upper mold and a lower mold for vulcanizing and molding the green tire, and a tire elevating apparatus for setting the green tire to the lower mold.

The green tire is molded by steps comprising mounting the green tire on the cradle, temporarily holding the green tire by the tire elevating apparatus, thereafter setting the green tire to the lower mold, and vulcanizing and molding the green tire between the lower mold and the upper mold.

The applicant of the present invention has already proposed a tire vulcanizing apparatus which solves a time loss in the molding step (Japanese Unexamined Patent Publication No. 2000-158447).

The prior tire vulcanizing apparatus is provided with, as shown in FIGS. 2A, 2B, 2C and 2D, a cradle 6 which receives a green tire T from a tire supplying apparatus 5 at a tire receiving position M1 moves the received green tire T to a tire supplying position M2, a tire elevating apparatus 8 which elevates at the tire supplying position M2 so as to hold the green tire T on the cradle 6, and sets the green tire T to a lower mold 7, and an upper mold 9 which elevates at a tire vulcanizing position M3 so as to vulcanize and mold the green tire T with respect to the lower mold 7.

Further, the structure is made such that a moving unit U in which the cradle 6 and the lower mold 7 are integrally connected is formed, and the lower mold 7 is reciprocated between the tire supplying position M2 and the tire vulcanizing position M3 at the same time when the cradle 6 is moved between the tire receiving position M1 and the tire supplying position M2 by reciprocating the moving unit U.

In the prior tire vulcanizing apparatus, since the moving unit U in which the cradle 6 and the lower mold 7 are integrally connected is formed, the green tire is supplied to the cradle 6 from the tire supplying apparatus 5 at a time of setting the green tire T to the lower mold 7, the lower mold 7 is moved to the tire vulcanizing position M3 from the tire supplying position M2 by setting the green tire T to the lower mold 7 and thereafter moving the moving unit U, and the cradle 6 is moved to the tire supplying position M2 from the tire receiving position M1.

As mentioned above, in the case that the lower mold 7 is moved from the tire supplying position M2 to the tire vulcanizing position M3, the cradle 6 is left at the tire supplying position M2 during the movement, and can not be supplied the green tire T.

Accordingly, the time at which the cradle 6 can receives the green tire T is limited to the time for setting the green tire T to the lower mold 7, so that the time for supplying the green tire T is shortened. Accordingly, there is a problem that the apparatus is hard to handle at a time of practical operation.

The present invention is made in order to solve the problem mentioned above, and an object of the present invention is to provide a tire vulcanizing apparatus and a tire vulcanizing method which can sufficiently secure a time for supplying a green tire by conveying the green tire to a tire supplying position during a vulcanizing and molding step which has the longest time in the tire vulcanizing step.

### DISCLOSURE OF THE INVENTION

In order to achieve the object mentioned above, in accordance with a first aspect of the present invention, there is provided a tire vulcanizing apparatus comprising:

a tire conveying apparatus which reciprocates between a conveyance waiting position and a tire supplying position, conveys a green tire received at the conveyance waiting position to the tire supplying position, and returns to the conveyance waiting position after the green tire is held at the tire supplying position by an tire elevating apparatus;

the tire elevating apparatus which elevates at the tire supplying position, ascends the green tire conveyed to the tire supplying position by the tire conveying apparatus to an ascent holding position while holding the green tire, and descends to a descent set position from the ascent holding position so as to set the green tire to a lower mold coming to the tire supplying position;

the lower mold which reciprocates between the tire supplying position and a tire vulcanizing position, to which the green tire is set at the tire supplying position by the tire elevating apparatus, and which is moved to the tire vulcanizing position from the tire supplying position in a state of setting the green tire, vulcanizes and molds the green tire with respect to the upper mold at the tire vulcanizing position, and thereafter is moved to the tire supplying position from the tire vulcanizing position; and

an upper mold which elevates at the tire vulcanizing position, vulcanizes and molds the green tire with respect to the lower mold at a descent vulcanizing position, and thereafter ascends to an ascent waiting position so as to move apart from the lower mold,

wherein the tire conveying apparatus reciprocates at one time between the conveyance waiting position and the tire supplying position during a period of vulcanizing and molding the green tire between the lower mold and the upper mold at the tire vulcanizing position.

Further, in accordance with a second aspect of the present invention, there is provided a tire vulcanizing method provided with a tire conveying apparatus which reciprocates between a tire supplying position and a conveyance waiting position, a tire elevating apparatus which elevates between an ascent holding position and a descent set position at the tire supplying position, a lower mold which reciprocates between the tire supplying position and a tire vulcanizing position, and an upper mold which elevates between a descent vulcanizing position and an ascent waiting position at the tire vulcanizing position, comprising:

a tire conveyance supplying step of moving the tire conveying apparatus from the conveyance waiting position to the tire supplying position so as to convey the green tire received at the conveyance waiting position to the tire supplying position;

a tire ascent holding step of ascending the green tire on the tire conveying apparatus to the ascent holding position by holding the green tire by the tire elevating apparatus after the tire conveyance supplying step;

a tire conveyance returning step of moving the tire conveying apparatus from the tire supplying position to the conveyance waiting position after the tire ascent holding step;

a tire descent setting step of descending the tire elevating apparatus from the ascent holding position to a descent setting position so as to set the green tire to the lower mold coming to the tire supplying position, after the tire ascent holding step;

a supply moving step of moving the lower mold in a state of setting the green tire from the tire supplying position to the tire vulcanizing position, after the tire descent setting step;

a tire vulcanizing step of vulcanizing and molding the green tire between the upper mold descending to the descent vulcanizing portion and the lower mold at the tire vulcanizing position, after the supply moving step;

a leaving step of ascending the upper mold to the ascent waiting position so as to leave from the lower mold, after the tire vulcanizing step; and

a return moving step of moving the lower mold from the tire vulcanizing position to the tire supplying position, after the leaving step,

wherein the tire conveyance supplying step to the tire conveyance returning step by the tire conveying apparatus are executed during the vulcanizing and molding step.

### BRIEF DESCRIPTION OF THE DRAWINGS

FIG. 1 is an explanatory view showing a process of a tire vulcanizing method in accordance with an embodiment of the present invention; and

FIG. 2 is an explanatory view showing a process of a conventional tire vulcanizing method.

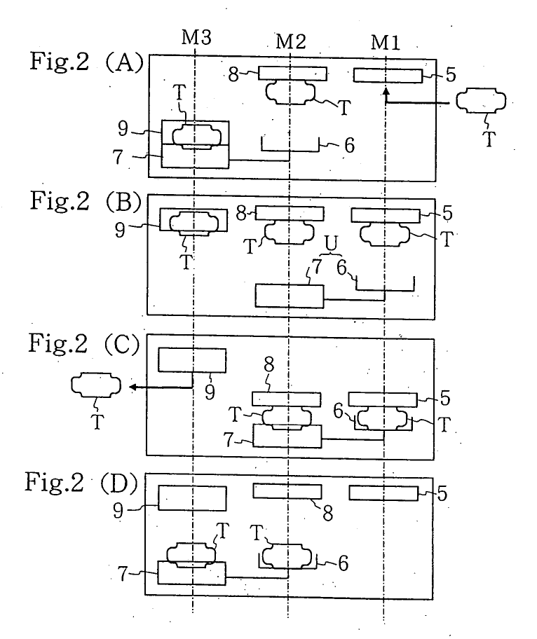

### DETAILED DESCRIPTION OF THE PREFERRED EMBODIMENTS

A description will be given below of a mode for carrying out the present invention on the basis of an embodiment shown in the accompanying drawings.

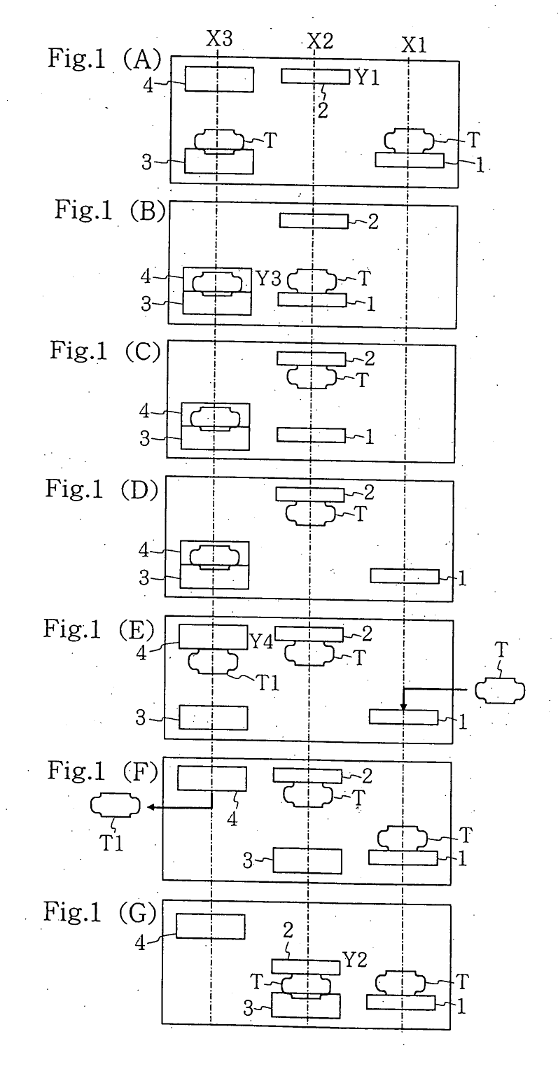

FIG. 1 is an explanatory view showing a process of a tire vulcanizing method in accordance with an embodiment of the present invention.

In the tire vulcanizing apparatus, three positions comprising a conveyance waiting position X1, a tire supplying position X2 and a tire vulcanizing position X3 are provided.

In the drawing, reference numeral 1 denotes a tire conveying apparatus. The tire conveying apparatus 1 reciprocates between a conveyance waiting position X1 and a tire supplying position X2. Reference numeral 2 denotes a tire elevating apparatus. The tire elevating apparatus 2 elevates between an ascent holding position Y1 and a descent setting position Y2 at the tire supplying position X2. Reference numeral 3 denotes a lower mold. The lower mold 3 reciprocates between the tire supplying position and a tire vulcanizing position X3. Reference numeral 4 denotes an upper mold. The upper mold 4 elevates between a descent vulcanizing position Y3 and an ascent waiting position Y4 at the tire vulcanizing position.

The tire conveying apparatus 1 conveys a green tire T received at the conveyance waiting position X1 to the tire supplying position X2, and is returned to the conveyance waiting position X1 after the green tire T is held by the tire elevating apparatus 2 at the tire supplying position X2.

The tire conveying apparatus 1 preferably employs an optionally movable structure such as a self-propelled supply car.

The tire elevating apparatus 2 is structured such as to ascend the green tire T conveyed to the tier supplying position X2 by the tire conveying apparatus 1 to the ascent holding position Y1 while holding, and to descend to the descent setting position Y2 from the ascent holding position Y1 so as to set the green tire T to the lower mold 3 coming to the tire supplying position X2.

The green tire T is set to the lower mold 3 by the tire elevating apparatus 2 at the tire supplying position X2. In this case, a center mechanism provided with a bladder (not shown) is provided in the lower mold 3, and the green tire T is set to the lower mold 3 while preventing the green tire T from being deformed in accordance with a shaping on the basis of a closely contact of the bladder with an inner surface of the green tire T caused by an expansion of the bladder.

As mentioned above, the tire elevating apparatus is structured such as to move from the tire supplying position X2 to the tire vulcanizing position X3 in a state of setting the green tire T, to vulcanize and mold the green tire T with respect to the upper mold 4 at the tire vulcanizing position X3 and thereafter to move to the tire supplying position X2 from the tire vulcanizing position X3.

The upper mold 4 is structured such as to vulcanize and mold the green tire T with respect to the lower mold 3 at the descent vulcanizing position Y3 and thereafter to ascend to the ascent waiting position Y4 so as to move apart from the lower mold 3.

Further, the tire conveying apparatus 1 is structured such as to reciprocate between the conveyance waiting position X1 and the tire supplying position X2 at one time during a period of vulcanizing and molding the green tire T between the lower mold 3 and the upper mold 4 at the tire vulcanizing position X3.

Next, a description will be given of a tire vulcanizing method.

A description will be first given of a step of supplying the green tire T by means of the tire conveying apparatus 1.

In a tire conveyance supplying step (FIG. 1B), the tire conveying apparatus 1 is moved from the conveyance waiting position X1 to the tire supplying position X2, and the green tire T received at the conveyance waiting position X1 is conveyed to the tire supplying position X2.

Next, there is executed a tire ascent holding step (FIG. 1C) of ascending the green tire T on the tire conveying apparatus 1 to the ascent holding position Y1 by holding the green tire by the tire elevating apparatus 2 after the tire conveyance supplying step (FIG. 1B).

Next, there is executed a tire conveyance returning step (FIG. 1D) of moving the tire conveying apparatus 1 from the tire supplying position X2 to the conveyance waiting position X1 after the tire ascent holding step (FIG. 1C).

In accordance with the steps mentioned above, the green tire T is supplied (for example, FIG. 1E) to the tire conveying apparatus 1 by a tire delivering apparatus (not shown) during the tire conveyance returning step (FIGS. 1D to 1G) in which the tire conveying apparatus 1 is moved at the conveyance waiting position X1, and thereafter each of the operations are repeated in the order of the tire conveyance supplying step (FIG. 1B) the tire ascent holding step (FIG. 1C) and the tire conveyance returning step (FIG. 1D) in the same manner as mentioned above.

Next, a description will be given of a tire vulcanizing and molding step by the lower mold 3 and the upper mold 4.

There is executed a tire descent setting step (FIG. 1G) of descending the tire elevating apparatus 2 from the ascent holding position Y1 to the descent setting position Y2 so as to set the green tire T to the lower mold 3 coming to the tire supplying position X2 from the tire vulcanizing position X3, after the tire ascent holding step (FIG. 1C).

Next, there is executed a supply moving step (FIG. 1A) of moving the lower mold 3 in a state of setting the green tire T from the tire supplying position X2 to the tire vulcanizing position X3, after the tire descent setting step (FIG. 1G).

There is executed a tire vulcanizing step (FIG. 1B) of vulcanizing and molding the green tire T between the upper mold descending to the descent vulcanizing portion Y3 and the lower mold 3 at the tire vulcanizing position X3, after the supply moving step (FIG. 1A).

Further, the tire conveyance supplying step (FIG. 1B), the tire ascent holding step (FIG. 1C) and the tire conveyance returning step (FIG. 1D) are executed during a period (FIGS. 1B to 1D) of executing the tire vulcanizing step.

Next, there is executed a leaving step (FIG. 1E) of ascending the upper mold 4 to the ascent waiting position Y4 so as to leave from the lower mold 3, after the tire vulcanizing step (FIG. 1D).

Further, there is executed a return moving step (FIG. 1F) of moving the lower mold 3 from the tire vulcanizing position X3 to the tire supplying position X2, after the leaving step (FIG. 1E).

The tire T1 after being vulcanized and molded are taken out from the upper mold 4 during a period (FIGS. 1F to 1G) of the return moving step (For example, FIG. 1F).

In the tire vulcanizing method mentioned above, since the lower mold 3 and the tire conveying apparatus 1 can independently move, a timing of moving the tire conveying apparatus 1 is not limited by the movement of the lower mold 3.

Accordingly, as mentioned above, it is possible to execute the tire conveyance supplying step (FIG. 1B), the tire ascent holding step (FIG. 1C) and the tire conveyance returning step (FIG. 1D) during a period (FIGS. 1B to 1D) of executing the tire vulcanizing step.

Accordingly, the green tire T can be conveyed to the tire supplying position X2 during the vulcanizing and molding step having a longest time in the tire vulcanizing step, the supplying tire for the green tire T can be sufficiently secured and it is possible to easily handle the green tire T.

In this case, in the present invention, one tire conveying apparatus may be employed for one tire vulcanizing apparatus, or one tire conveying apparatus may be used in common for a plurality of tire vulcanizing apparatuses.

In the case that one tire conveying apparatus is provided, for example, for a plurality of tire vulcanizing apparatuses arranged in front, rear, right and left sides, the structure may be made such that the green tires are stocked in a lump, and the green tire is mounted and supplied to the tire conveying apparatus in correspondence to a production schedule and an operating condition of each of the tire vulcanizing apparatuses.

Further, although being omitted in the embodiment mentioned above, it goes without saying that the vulcanized and molded tire taken out from the upper mold can be continuously delivered to the PCI apparatus (pressurizing and cooling apparatus) so as to be stabilized in a molding state.

### INDUSTRIAL APPLICABILITY

As described above, in accordance with the tire vulcanizing apparatus and the tire vulcanizing method of the present invention, since the tire conveyance supplying step, the tire ascent holding step and the tire conveyance returning step are executed during the period of executing the tire vulcanizing step, the green tire can be conveyed to the tire supplying position during the longest vulcanizing and molding step in the tire vulcanizing step, so that it is possible to obtain the effect that the tire for supplying the green tire can be sufficiently secured and the green tire can be easily handled.

What is claimed is:

1. A tire vulcanizing apparatus comprising:
a tire conveying apparatus which reciprocates between a conveyance waiting position and a tire supplying position, conveys a green tire received at the conveyance waiting position to the tire supplying position, and returns to the conveyance waiting position after the green tire is held at the tire supplying position by an tire elevating apparatus;
the tire elevating apparatus which elevates at said tire supplying position, ascends the green tire conveyed to the tire supplying position by said tire conveying apparatus to an ascent holding position while holding the green tire, and descends to a descent set position from the ascent holding position so as to set the green tire to a lower mold coming to said tire supplying position;
the lower mold which reciprocates between said tire supplying position and a tire vulcanizing position, to which the green tire is set at said tire supplying position by the tire elevating apparatus, and which is moved to the tire vulcanizing position from the tire supplying position in a state of setting the green tire, vulcanizes and molds the green tire with respect to the upper mold at the tire vulcanizing position, and thereafter is moved to the tire supplying position from the tire vulcanizing position; and
an upper mold which elevates at said tire vulcanizing position, vulcanizes and molds the green tire with respect to said lower mold at a descent vulcanizing position, and thereafter ascends to an ascent waiting position so as to move apart from said lower mold,
wherein said tire conveying apparatus reciprocates at one time between the conveyance waiting position and the tire supplying position during a period of vulcanizing and molding the green tire between the lower mold and the upper mold at the tire vulcanizing position.

2. A tire vulcanizing method provided with a tire conveying apparatus which reciprocates between a tire supplying position and a conveyance waiting position, a tire elevating apparatus which elevates between an ascent holding position and a descent set position at said tire supplying position, a lower mold which reciprocates between said tire supplying position and a tire vulcanizing position, and an upper mold which elevates between a descent vulcanizing position and an ascent waiting position at said tire vulcanizing position, comprising:
a tire conveyance supplying step of moving the tire conveying apparatus from the conveyance waiting position to the tire supplying position so as to convey the green tire received at the conveyance waiting position to the tire supplying position;
a tire ascent holding step of ascending the green tire on the tire conveying apparatus to the ascent holding position by holding the green tire by the tire elevating apparatus after said tire conveyance supplying step;
a tire conveyance returning step of moving the tire conveying apparatus from the tire supplying position to the conveyance waiting position after said tire ascent holding step;
a tire descent setting step of descending the tire elevating apparatus from the ascent holding position to a descent setting position so as to set the green tire to the lower mold coming to the tire supplying position, after said tire ascent holding step;
a supply moving step of moving the lower mold in a state of setting the green tire from the tire supplying position to the tire vulcanizing position, after said tire descent setting step;
a tire vulcanizing step of vulcanizing and molding the green tire between the upper mold descending to the descent vulcanizing portion and said lower mold at the tire vulcanizing position, after said supply moving step;
a leaving step of ascending said upper mold to the ascent waiting position so as to leave from said lower mold, after said tire vulcanizing step; and
a return moving step of moving said lower mold from the tire vulcanizing position to the tire supplying position, after said leaving step,
wherein the tire conveyance supplying step to the tire conveyance returning step by said tire conveying apparatus are executed during said vulcanizing and molding step.
